(19) United States
(12) Patent Application Publication
(10) Pub. No.: US 2026/0107111 A1
(43) Pub. Date: Apr. 16, 2026

(54) A METHOD OF CALIBRATING AN INDOOR POSITIONING SYSTEM FOR LOCATION BASED SERVICES USING RADIO FREQUENCY BEACONS

(71) Applicant: MOBYYOU B.V., Eindhoven (NL)

(72) Inventors: Jeroen PIETRYGA, Eindhoven (NL); Petrus Joannes Wilhelmus VAN HERP, Eindhoven (NL)

(21) Appl. No.: 19/114,154

(22) PCT Filed: Sep. 22, 2023
(86) PCT No.: PCT/NL2023/050492

§ 371 Date: Mar. 21, 2025

(30) Foreign Application Priority Data
Sep. 22, 2022 (NL) 2033109

(51) Int. Cl. H04W 4/029; H04B 17/318; H04W 4/33

(52) U.S. Cl. CPC H04W 4/029; H04B 17/318; H04W 4/33

(57) ABSTRACT

A method and a computer program for calibrating a positioning system for location based services for a mobile user equipment using at least one Radio Frequency, RF, beacon, said method comprising the steps of:—obtaining a first signal strength value between said at least one RF beacon and said mobile user equipment;—storing said first signal strength value and a corresponding mobile user equipment identification value into a storage means in said mobile user equipment;—obtaining a calibration algorithm corresponding to said mobile user equipment;—correcting said first signal strength value into a second signal strength value, based on said calibration algorithm; wherein said calibration algorithm is comprised of at least one attribute of:—a use value, comprising information on an operating condition of said mobile user equipment, at least corresponding to a display of said mobile user equipment being active of off;—a hardware value, comprising information on a manufacturer and/or product version information of said mobile user equipment;—a environmental value, comprising information on the environment of said at least one RF beacon which can be affect said first signal strength value.

A method of calibrating an indoor positioning system for location based services using radio frequency beacons.

### FIELD OF THE INVENTION

The present invention generally relates to the field of indoor positioning systems and, more specifically, to calibrating indoor positioning systems for location based services using radio frequency beacons. The present invention further relates to a computer program product for operating a mobile communication device and calibrating such indoor positioning systems.

### BACKGROUND OF THE INVENTION

Indoor positioning systems may be employed for location based services. With such location based services for example advertising content can be controlled and pushed to customers in or in the neighbourhood of a shop of other commercial environment such as on a fair, at a business meeting location or a public transport location. Based on a determined the position of the customer, or more in general a user, a merchant or party acting on behalf of the merchant, can provide information to a mobile device of the user. The information provided may include advertisement, but also data relating to transactions such as a financial transaction to buy certain goods, or to accept certain services, as for example a public transport ticket.

In general, several location based services have been used effectively for quite some time now, as for example based on global positioning systems. Such global positioning systems are only suitable for course location determination and also for outdoor applications due to the signal attenuation caused by construction materials of the building and objects present therein as well as the reflections by such materials and objects which may cause multi-path propagations and the like.

A technique which is more suitable for indoor positioning (or corresponding to an indoor room level accuracy) is to make use of local Radio Frequency, RF beacons within the building. Wireless technology can be used to determine a location of a wireless communication device within the building. And since a user may carry such an associated communication device, the location of the user may be derived by communication between the communication device and the beacons such that a certain service, e.g. processing the financial transaction of a ticket when entering a train, bus or other type of public transport, may be performed automatically upon detection of the communication device and thus the user, being within a certain range of the good or service, as determined by communication data between the communication device and the one or several beacons. This does not only imply that the electronic devices may be considered RF beacons transmitting the RF signals, and the communication device such as a smartphone receiving the RF signals, this may also work the other way around, wherein the communication device transmits the RF signals and the electronic devices such as luminaires may function as receivers for the RF signals.

With the increase in the number of location based services, the density of these services, at least for some location as in busy shopping environments, may increase as well. For some location based services it may be sufficient to determine positions in a course manner, whereas for other location based services very accurate positioning is required. For example, pushing general service information on a mobile phone of a customer within a retail store, may be done without accurate positioning as long as it may be determined that the customer is somewhere within the store, whereas for product information a high accuracy is required as the information is only considered relevant when the customer is located in close proximity of said product. For certain applications high accuracy may even be a requirement, e.g. in transactions or ticketing for public transportation whereas it is mandatory that the service is only triggered when the customer making use of that particular public transport such as a bus, and not when he or she is near the bus.

To increase the accuracy of the positioning systems it may be known to increase the number of RF beacons, or to rely on additional technologies such as global positioning systems, or for example sensors in the mobile user equipment. However, increasing the number of RF beacons may not solve the drawback that signal strength between the mobile user equipment and the RF beacons is not steady and may be biased by various factors, and relying on additional sensors adds complexity, and requirements for compatibility of the use of the location based services.

As such, there is a need to increase the accuracy for positioning system for location based services for a mobile user equipment using at least one Radio Frequency, RF, beacon, in which at least some of the above mentioned drawbacks have been overcome.

### SUMMARY OF THE INVENTION

It would be advantageous to increase the accuracy of indoor positioning systems. It is therefore desirable to obtain a method by which indoor positioning systems can be at least partially calibrated to increase the accuracy and speed of detection. It is further desirable to obtain a computer program product for calibrating such indoor positioning systems.

To address one or more of these concerns, in a first aspect of the present disclosure, a method is proposed of calibrating a positioning system for location based services for a mobile user equipment using at least one Radio Frequency, RF, beacon, said method comprising the steps of:
obtaining a first signal strength value between said at least one RF beacon and said mobile user equipment;
storing said first signal strength value and a corresponding mobile user equipment identification value into a storage means in said mobile user equipment;
obtaining a calibration algorithm corresponding to said mobile user equipment;
correcting said first signal strength value into a second signal strength value, based on said calibration algorithm;
wherein said calibration algorithm is comprised of at least one attribute of:
   a use value, comprising information on an operating condition of said mobile user equipment, at least corresponding to a display of said mobile user equipment being active of off;
   a hardware value, comprising information on a manufacturer and/or product version information of said mobile user equipment;
   a environmental value, comprising information on the environment of said at least one RF beacon which can be affect said first signal strength value.

As indicated, location based services that rely on accurate positioning systems are challenging as determining positions with RF beacons is complex for several reasons. For example, the complexity of how wireless communication signals propagate through buildings. Several objects such as walls, ceilings, furniture, electrical equipment may affect the signal transmission in such a way that accurate location detection is cumbersome based on straightforward signal strength detection. To increase the accuracy, additional measures are required.

The present disclosure is based on the insight, that such additional measures should not require additional hardware or increase the complexity of the system, but employ information which is already present or which can be obtained in such a way that it does not require complex additional measures.

It has been found, that several types of information may already be present which information has a certain level of predictability on how the signals propagate. This information can be used to calibrate the communication between the mobile user equipment and the beacon to increase the accuracy of the positioning system to improve the location based services.

According to the present disclosure, the information is contained in a calibration algorithm which algorithm may be used to calibrate the positioning system. The calibration provides a type of profiling for each individual user and/or device. The profile or calibration algorithm for that particular user equipment is corresponded with the user equipment in a database and as such allows a first initial received signal to be calibrated in accordance with a calibration algorithm or personal profile which corresponds to that particular device or mobile user equipment.

The calibration is performed on the basis of received signal strengths, which is a typical measure for determining a distance between two network nodes, i.e. in this case, a mobile user equipment and a RF beacon. The stronger the signal the nodes. This may at least provide relative distance measurements and from the signal strengths, is may be determined if the nodes distances, between two measurements, increases or decreases. It is however challenging and typically involves a high level of inaccuracy, to perform absolute distance measurements.

The present disclosure proposes to calibrate such signal strength values, with a calibration algorithm by use of one or more of a class of information values or attributes. These attributes of the algorithm are classified into information related to the use of the mobile user equipment, the hardware of the mobile user equipment, the environment of the mobile user equipment and the RF beacons. In an example, additional attribute classifications may be used, such as historical information and reference measurement information.

It is expressed that the signal strength may comprise Received Signal Strength Indicator, RSSI, but may in addition or alternatively, also comprise a time of flight signal in which a measurement is performed of the time taken by an object, particle or wave (be it acoustic, electromagnetic, etc.) to travel a distance through a medium.

The first category or class of information relates to the use of the mobile user equipment, and may comprise information on the state of the mobile user equipment, at least comprising the display. When the display is on, it can be concluded that the device is in use and thus in the left or right hand of its user, and not in a bag, or pocket. As the signal propagation for a mobile user equipment is quite different from having the device in the user hand as compared to in a bag or pocket, resulting from external factors such as absorption, interference or diffraction. The inventors have determined to what extent the signal strength decreases when the mobile user equipment is kept in the users pocket or for example in a bag, or in other words, to what degree the signal strength increases when it is in the hand of its user. The first, original or initial signal strength can be corrected for this to obtain a new, second, corrected or calibrated signal strength value which can be used to perform more accurate position determination and thereby improved location based services. It is emphasized that the state of the display is merely one of the examples of use information attribute for the calibration algorithm and that other use information may also be contained in the use value.

The second class of information is related to the type of hardware of the user equipment. It has been determined that there is a typical and classifiable difference between hardware manufactures when it comes to signal strength. Certain mobile communication standards may prescribe employing certain ranges in signal strength. Bluetooth for example, works with broadcasting signals at a broadcast power value in the range between 2-4 dBm, which converts to a Received Signal Strength Indicator, RSSI, strength between around −26 (corresponding to a few cm) and −100 (which may correspond to approximate 40 to 50 meter). It has been determined that within these standard ranges, manufactures have different implementations of the standard, which result in differences in RSSI. When the manufacturer is known, this information can be used as a hardware correction value in the algorithm. Some manufacturers may require a positive or increasing bias value, whereas other may require a negative value. Further, correction of signal strengths may even be classified for models of a particular hardware manufacturer. Some models of mobile user equipment may for example be know to have metal or glass bodies which have a different effect on the signal strength. When the positioning system for the location based service is able to determine not only the hardware manufacturer, but also or alternatively, the model of the mobile user equipment, the signal strength can be calibrated by correction with a predefined value corresponding to a class.

Finally, the third level or class of information relates to the environment, which involves any information on the environment by which the signal between the mobile user equipment and the RF beacon is affected. Typically that would involve information on building or room in which the RF beacons are located. If these are located in a busy commercial environment such as a shopping mall, it may be expected that the level of interference by other mobile communication devices is higher than when the beacons are located in a residential environment. Also information on objects close to the beacons may be relevant when these object may affect the level of interference, for example large metallic or other signal reflecting surfaces like windows or the like.

When it is already known that the beacon is located inside or close to several metal surfaces, the level of reflection, absorption and interference may be estimated and corrected for in the environmental value of the calibration algorithm.

In an example, at least one of the steps of obtaining and storing the first signal strength value, comprises obtaining the calibration algorithm and correcting the first signal strength value into a second signal strength value are performed by the mobile user equipment.

In an example, at least one of the steps of obtaining and storing the first signal strength value, obtaining the calibration algorithm and correcting the first signal strength value into a second signal strength value are performed by the at least one RF beacon.

In an example, the positioning system comprises at least two RF beacons, and wherein the calibration algorithm further comprises a triangulation value, comprising distance between the mobile user equipment and the at least two RF beacons calculated by triangulation.

In an example, the calibration algorithm is stored in a database.

In an example, the calibration algorithm is stored in a database located on a remote storage device being in communicative contact with the mobile user equipment or the at least one RF beacons.

In an example, the calibration algorithm is stored in a distributed database located on a plurality of mobile user equipment comprising the mobile user equipment using the location based services.

In an example, the calibration algorithm is stored in a distributed database located on each of the at least one RF beacons.

In an example, the calibration comprises at least two of the attributes.

In an example, the calibration comprises at least three of the attributes.

In an example, the calibration algorithm at least comprises the attributes of the use value and the hardware value.

In an example, the calibration algorithm further comprises the attribute of the environmental value.

In an example, the calibration algorithm further comprises an attribute of a historical value, comprising information on signal strength values previously stored for the corresponding mobile user equipment identification value.

In an example, the calibration algorithm further comprises an attribute of a refence value, comprising information on signal strength values between the mobile user equipment and a reference RF beacon of which a distance is known.

In an example, the calibration algorithm utilizes a calibration classification for classifying the user equipment in one of a plurality of discrete calibration classifications corresponding to ranges of absolute values in the calibration algorithm.

In an example, the method further comprises the step of redefining the calibration classification by iteratively updating at least one of the attributes of the calibration algorithm.

In an example, each attribute of the calibration algorithm comprises a corresponding weight factor.

In an example, the first signal strength value is a Received Signal Strength Indicator, RSSI.

In an example, the signal strength is determined by an aggregation of signal strengths of a plurality of beacons.

In a second aspect, there is provided a computer program product loadable into the internal memory of a computer comprising computer program code portions for calibration of an indoor positioning system by performing the steps according to any of the previous claims 1-12, when the computer program product is executed by one or more cores of the computer.

The method may be effectively performed by a suitable programmed processor or programmable controller, such as a micro-processor or micro controller provided with a communication device such as a smartphone, tablet, portable (laptop) computer, smartwatch or the like.

As such, the present disclosure is also directed to a computer program product, comprising a readable storage medium, comprising instructions which, when executed on at least one processor, cause the at least one processor to carry out the method according to any of the embodiments as disclosed above.

### BRIEF DESCRIPTION OF THE DRAWINGS

The invention will be further elucidated on the basis of non-limiting examples shown in the figures, wherein:

FIG. 1 shows the steps of the method of calibration of a positioning system according to the present disclosure;

FIG. 2 shows a positioning system 1 for location based services according to the present disclosure.

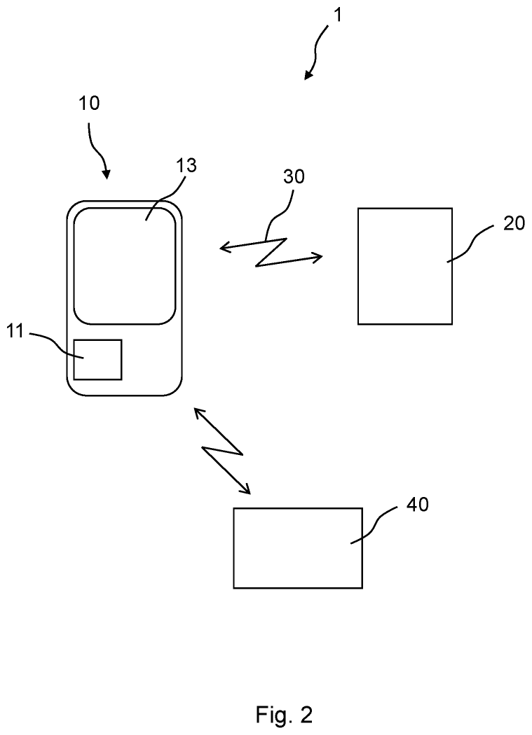

### DETAILED DESCRIPTION

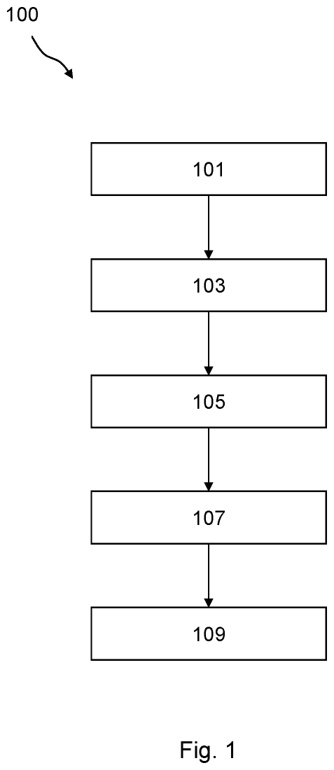

FIG. 1 shows a method 100 of calibrating a positioning system 1 for location based services for a mobile user equipment 10 using a Radio Frequency, RF, beacon 20. The method 100 comprises the steps summed up below. In this embodiment, the steps are performed by the mobile user equipment 10, embodied as mobile phone 10. In another embodiment, one or more steps of the method 100 can be performed in a similar manner by the RF beacon 20.

In a first step 101 of the method 100, a first signal strength value of a communication signal 30 between the RF beacon 20 and the mobile phone 10 is obtained, wherein the first signal strength value is a Received Signal Strength Indicator, RSSI.

In a second step 103, the first signal strength value and a corresponding mobile user equipment identification value is stored into a storage means 11 in the mobile phone 10.

In a subsequent step 105 of the method 100, a calibration algorithm corresponding to the mobile phone 10 is obtained. The calibration algorithm is stored in a database 40, located on a remote storage device being in communicative contact with the mobile phone 10, or the calibration algorithm is stored in a distributed database 40, either located on the RF beacon 20 or located on a plurality of mobile user equipment, which comprises the mobile phone 10, using the location based services.

The calibration algorithm comprises at least one, preferably all, of the following attributes:
a use value, comprising information on an operating condition of the mobile phone 10, at least corresponding to a display 13 of the mobile phone 10 being active or off;
a hardware value, comprising information on a manufacturer and/or product version information of the mobile phone 10;
a environmental value, comprising information on the environment of the RF beacon 20 which can be affect the first signal strength value;
a historical value, comprising information on signal strength values previously stored for the mobile user equipment identification value;
a refence value, comprising information on signal strength values between the mobile phone 10 and a reference RF beacon of which a distance is known.

In another embodiment (not shown), the positioning system 1 comprises two or more RF beacons 20, wherein the calibration algorithm furthermore comprises a triangulation value, comprising the distance between the mobile phone 10 and the respective RF beacons 20, calculated by triangulation. In this case, the signal strength is determined by an aggregation of signal strengths of the plurality of beacons 20.

Each of the above mentioned attributes of the calibration algorithm comprises a corresponding weight factor. The more of these attributes available for the calibration algorithm, the more accurate the calibrating process for the positioning system 1 can be performed.

The calibration algorithm utilizes a calibration classification for classifying the mobile phone 10 in one of a plurality of discrete calibration classifications corresponding to ranges of absolute values in the calibration algorithm. In a further step 107 of the method 100, the calibration classification is redefined by iteratively updating at least one of the attributes of the calibration algorithm.

In a final step 109, the first signal strength value is corrected into a second signal strength value, based on the calibration algorithm.

The method 100 is performed by a computer program product loadable into the internal memory of a computer, for example of the mobile phone 10. The computer program product comprises computer program code portions for performing the steps of the method 100, when the computer program product is executed by one or more cores of the computer.

1. A method of calibrating a positioning system for location based services for a mobile user equipment using at least one Radio Frequency, RF, beacon, said method comprising the steps of:
obtaining a first signal strength value between said at least one RF beacon and said mobile user equipment;
storing said first signal strength value and a corresponding mobile user equipment identification value into a storage means in said mobile user equipment;
obtaining a calibration algorithm corresponding to said mobile user equipment;
correcting said first signal strength value into a second signal strength value, based on said calibration algorithm;
wherein said calibration algorithm is comprised of at least one attribute of:
a use value, comprising information on an operating condition of said mobile user equipment, at least corresponding to a display of said mobile user equipment being active or off;
a hardware value, comprising information on a manufacturer and/or product version information of said mobile user equipment;
a environmental value, comprising information on the environment of said at least one RF beacon which can be affect said first signal strength value.

2. The method of calibrating a positioning system according to claim 1, wherein said at least one of said steps op obtaining and storing said first signal strength value, obtaining said calibration algorithm and correcting said first signal strength value into a second signal strength value are performed by said mobile user equipment.

3. The method of calibrating a positioning system according to claim 1, wherein at least one of said steps op obtaining and storing said first signal strength value, obtaining said calibration algorithm and correcting said first signal strength value into a second signal strength value are performed by said at least one RF beacon.

4. The method of calibrating a positioning system according to claim 1, wherein said positioning system comprises at least two RF beacons, and wherein said calibration algorithm further comprises a triangulation value, comprising distance between said mobile user equipment and said at least two RF beacons calculated by triangulation.

5. The method of calibrating a positioning system according to claim 1, wherein said calibration algorithm is stored in a database.

6. The method of calibrating a positioning system according to claim 1, wherein said calibration algorithm is stored in a database located on a remote storage device being in communicative contact with said mobile user equipment or said at least one RF beacons.

7. The method of calibrating a positioning system according to claim 1, wherein said calibration algorithm is stored in a distributed database located on a plurality of mobile user equipment comprising said mobile user equipment using said location based services.

8. The method of calibrating a positioning system according to claim 1, wherein said calibration algorithm is stored in a distributed database located on each of said at least one RF beacons.

9. The method of calibrating a positioning system according to claim 1, wherein said calibration comprises at least two of said attributes.

10. The method of calibrating a positioning system according to claim 1, wherein said calibration comprises at least three of said attributes.

11. The method of calibrating a positioning system according to claim 1, wherein said calibration algorithm at least comprises said attributes of said use value and said hardware value.

12. The method of calibrating a positioning system according to claim 11, wherein said calibration algorithm further comprises said attribute of said environmental value.

13. The method of calibrating a positioning system according to claim 1, wherein said calibration algorithm further comprises an attribute of a historical value, comprising information on signal strength values previously stored for said corresponding mobile user equipment identification value.

14. The method of calibrating a positioning system according to claim 1, wherein said calibration algorithm further comprises an attribute of a refence value, comprising information on signal strength values between said mobile user equipment and a reference RF beacon of which a distance is known.

15. The method of calibrating a positioning system according to claim 1, wherein said calibration algorithm utilizes a calibration classification for classifying said user equipment in one of a plurality of discrete calibration classifications corresponding to ranges of absolute values in said calibration algorithm.

16. The method of calibrating a positioning system according to claim 15, wherein said method further comprises the step of redefining said calibration classification by iteratively updating at least one of said attributes of said calibration algorithm.

17. The method of calibrating a positioning system according to claim 1, wherein each attribute of said calibration algorithm comprises a corresponding weight factor.

18. The method of calibrating a positioning system according to claim 1, wherein said first signal strength value is a Received Signal Strength Indicator, RSSI.

19. The method of calibrating a positioning system according to claim 1, wherein said signal strength is determined by an aggregation of signal strengths of a plurality of beacons.

20. A computer program product loadable into the internal memory of a computer comprising computer program code portions for calibration of an indoor positioning system by performing the steps according to claim 1, when said computer program product is executed by one or more cores of said computer.
